(19) United States
(12) Patent Application Publication
(10) Pub. No.: US 2015/0046532 A1
(43) Pub. Date: Feb. 12, 2015

(54) METHOD FOR SUPPORTING AUTOMATED METADATA AUGMENTATION IN A HIERARCHICAL LEVEL ARCHITECTURE FOR MACHINE-TO-MACHINE (M2M) CLOUD COMPUTING AND CORRESPONDING SYSTEM

(71) Applicant: NEC Europe Ltd., Heidelberg (DE)

(72) Inventor: Piotr Szczytowski, Mannheim (DE)

(21) Appl. No.: 14/385,571

(22) PCT Filed: Mar. 18, 2013
(86) PCT No.: PCT/EP2013/055571

§ 371 Date: Sep. 16, 2014

(30) Foreign Application Priority Data
Mar. 19, 2012 (EP) 12160142.1

(51) Int. Cl. H04L 29/08

(52) U.S. Cl. CPC H04L 67/2804; H04L 67/104
USPC 709/204

(57) ABSTRACT

A method for supporting automated metadata augmentation in a hierarchical level architecture for machine-to-machine (M2M) cloud computing, wherein metadata is employed to provide descriptive information about entities, wherein said entities are generated at a lower level of said architecture, in particular at the bottom level of said architecture, wherein said entities are propagated from said lower level, in particular via one or more levels, upwards to an upper level of said architecture, in particular to the application level of said architecture, and wherein metadata is added to said entities on one or more of the levels of said architecture, is characterized in that feedback information based on one or more of said entities is generated at said upper level of said architecture, and wherein said feedback information is propagated downwards in said architecture. Furthermore, a corresponding system is disclosed.

The present invention relates to a method for supporting automated metadata augmentation in a hierarchical level architecture for machine-to-machine (M2M) cloud computing, wherein metadata is employed to provide descriptive information about entities, wherein said entities are generated at a lower level of said architecture, in particular at the bottom level of said architecture, wherein said entities are propagated from said lower level, in particular via one or more levels, upwards to an upper level of said architecture, in particular to the application level of said architecture, and wherein metadata is added to said entities on one or more of the levels of said architecture.

Furthermore, the present invention relates to a system for supporting automated metadata augmentation, wherein said system comprises a hierarchical level architecture for machine-to-machine (M2M) cloud computing, wherein said system is configured to employ metadata for providing descriptive information about entities, to generate entities at a lower level of said architecture, in particular at the bottom level of said architecture, to propagate said entities from said lower level, in particular via one or more levels, upwards to an upper level of said architecture, in particular to the application level of said architecture, and to add metadata to said entities on one or more of the levels of said architecture.

In the context of machine-to-machine (M2M) cloud computing a large quantity of data is generated and stored. To this extent, it is problematic that the data in its raw form has only limited usage to the third party users of data, e.g. for applications that not necessary generated and/or stored the data. Therefore metadata is employed in order to describe individual instances of application data or the data content. Without the metadata only dedicated applications can properly identify the data. For example, a temperature measurement does not represent much value unless the location at which the measurement was taken is known.

Thus, metadata can be added, wherein the metadata provides additional description of the data object which represents the measurement.

A well-known approach to augment metadata is for a metadata specialist to manually edit or generate metadata. However, performing manual metadata augmentation is cumbersome and error prone. Additionally once augmented metadata may become invalid or false. Furthermore, generating high level metadata in many cases involves time and resource demanding processing.

It is therefore an object of the present invention to improve and further develop a method and a system for supporting automated metadata augmentation in a hierarchical level architecture for machine-to-machine (M2M) cloud computing of the initially described type in such a way that, by employing mechanisms that are readily to implement, an increased performance for M2M-based systems is achieved in an efficient way.

In accordance with the invention, the aforementioned object is accomplished by a method comprising the features of claim 1. According to this claim such a method is characterized in that feedback information based on one or more of said entities is generated at said upper level of said architecture, and wherein said feedback information is propagated downwards in said architecture.

Furthermore, the aforementioned object is accomplished by a system comprising the features of independent claim 17. According to this claim, such a system is characterized in that said system is further configured to generate feedback information based on one or more of said entities at said upper level of said architecture and to propagate said feedback information downwards in said architecture.

According to the invention it has first been recognized that in the context of machine-to-machine cloud computing an enormous improvement can be achieved if the aggregated information and knowledge of higher levels is also available at lower levels of the hierarchical level architecture. Specifically, aggregated and/or processed information data of a higher level is to be provided to a lower level of the hierarchical level architecture. Furthermore, it has been recognized that the quality of metadata relating to an entity on the lower level can be significantly improved by generating feedback information at the upper level of the architecture, wherein the feedback information is based on information of received entities from a lower level of the architecture. Upon generating the feedback information, the feedback information is back-propagated downwards to the lower level of the architecture. Thus, the entities located in the lower level, e.g. in a gateway, can be augmented with the feedback information, e.g. in the form of additional metadata. Thus, the method and the system according to the invention enable an increased performance for M2M-based systems in an efficient way, in particular by improving the quality of metadata. Furthermore, the higher quality metadata may also translate in the faster processing and may lead to more accurate results.

It is to be noted that the term entity is mentioned in the sense of a data object representing machine-to-machine related data. An entity may include raw data, metadata and/or added metadata. The entity may also be generated by incorporating and/or merging one or more existing entities.

According to a preferred embodiment the entities may include device-generated and/or device-originated information. For example, an entity includes sensor-generated information that comprises a value measured by a sensor located at the bottom level of the architecture.

According to a further preferred embodiment the entities—e.g. originated by a device of the bottom level—may be propagated via one or more gateways/agents of one or more levels of the architecture and/or via a cloud platform to an application of the application level of the architecture.

Furthermore, it may be provided that the gateways comprise a metadata engine for adding metadata to the entities, wherein the metadata is based on aggregated information obtained by one or more entities originated from a lower level of the architecture, and wherein the entities with the added metadata are further propagated upwards within the architecture for further aggregation. Thus gateways and/or agents being placed higher in the hierarchy of the architecture can easily aggregate entities, i.e. data and/or metadata, originating from gateways and/or agents of the lower level of the architecture. Subsequently, the gateways/agents of the higher level may propagate the aggregated information further within the hierarchy of the architecture to allow for further aggregation. The rule used for generating and/or aggregating the metadata may depend on the gateway/agent metadata which specifies the inherent properties of the gateway or agent. The rule may further depend on the set of metadata transformations being possible for the gateway or agent. The difference between a gateway and an agent is that the agent has more logic functionality than the gateway.

According to a preferred embodiment the feedback information may be created and/or derived on the basis of aggregated information which is obtained by one or more entities originated from a lower level of the architecture.

Advantageously, it may be provided that the feedback information is created and/or derived on the basis of results from application processing at the application level of the architecture.

In a preferred embodiment, it may be provided that the feedback information includes a new entity with preferably completely new information data. For example, the new information data may result from processed and/or aggregated entities, in particular by an application at the application level.

According to a preferred embodiment the feedback information may include information data related to an existing entity, wherein the feedback information is added to the existing entity as additional metadata. Adding feedback information as metadata to the existing entity may be performed by a metadata engine which is located at a gateway, agent, etc. where the feedback information is received from the higher level for using at the lower level of the architecture. Thus, the feedback information may be included as additional metadata in the associated entity.

Advantageously, the feedback information may include a calculated mean value, a deviation value, an average deviation value and/or a trend value, etc. as information data. Thus, at a higher level of the architecture, the aggregated information is processed and the result of the data processing is back-propagated in the form of the feedback information to the lower level.

Advantageously, it may be provided that the feedback information includes as information data a rating regarding the Quality of Information (QoI) of an existing entity, wherein the rating relates to the fitness, in particular a rating relating to a valuation of usefulness and/or correctness, of the entity and/or the metadata of the existing entity. The rating and the Quality of Information respectively may be stored as well defined metadata. Thus, a mechanism is provided that enables maintaining the validity of existing entities and/or the metadata of the existing entities.

According to a preferred embodiment a conflict resolution may be performed in case of contradicting feedback information is received from different creators generating feedback information. For example, in case different applications provide a rating regarding the Quality of Information to the lower level, it may occur that the ratings are conflicting or contradictory. In this case a further evaluation for conflict resolution may be required in order to get a plausible rating.

According to a preferred embodiment the feedback information may be employed for augmenting, updating and/or maintaining entities at one or more of the lower levels of the architecture, wherein the entities are further propagated within the architecture. Thus, the entities are more valuable by updating and/or augmenting their metadata.

According to an advantageous embodiment entities may be shared by applications of the application level via the cloud platform. Thus, entities with augmented and valuable metadata can be used in an efficient way by other applications, because it can be avoided that the other applications processing the same or similar set of data for the same purpose and/or perform superfluous and expensive calculations.

Advantageously, it may be provided that the sharing of the entities is implemented by establishing an accounting function for valuing the entities and/or the metadata of the entities at the level of the cloud platform, wherein the accounting function provides the entities and/or the metadata of the entities to applications of the application level. Thus, by implementing the accounting function for the entities and/or metadata of the entities creates the incentives for the metadata creators to offer their metadata to third-party users. Thus the QoI and value of entities that are stored in the cloud platform is increased.

Advantageously, an application that provides feedback information to the accounting function may be rewarded with a credit, wherein the credit is employed to access other entities being provided by the accounting function.

According to a further preferred embodiment, the entities may include metadata describing static properties of the entities, wherein the entities further include one or more context attributes describing variable properties of the entities, and wherein the context attributes include descriptive metadata and a value.

There are several ways how to design and further develop the teaching of the present invention in an advantageous way. To this end it is to be referred to the patent claims subordinate to patent claim 1 on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawing

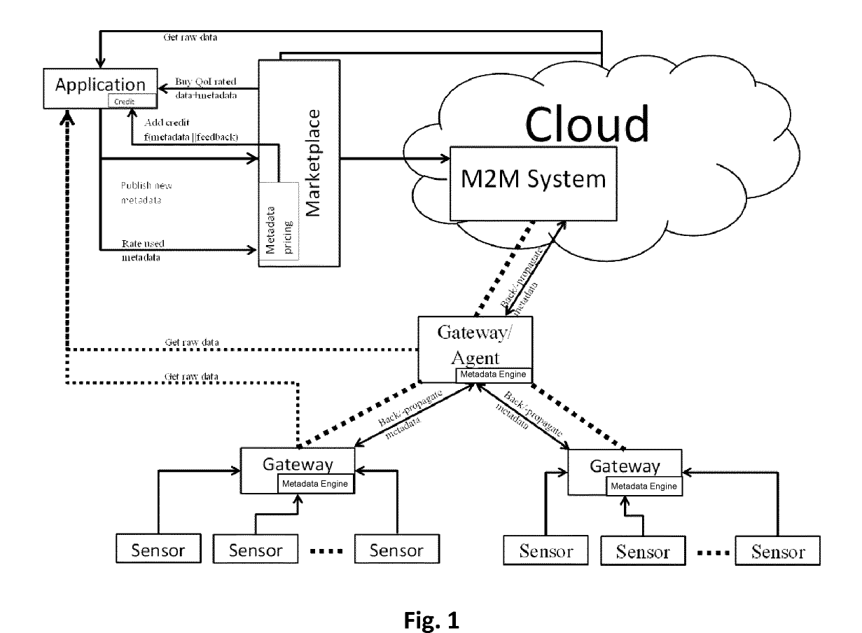

FIG. 1 is a schematic view illustrating an example of an application scenario of an embodiment of a method or a system according to the present invention,

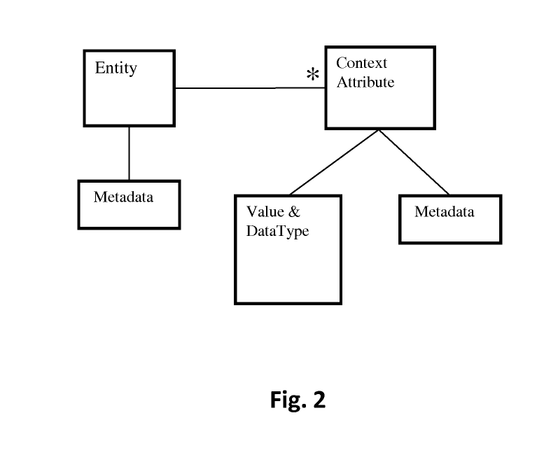

FIG. 2 is a schematic view illustrating an example of an information model for an embodiment of the present invention,

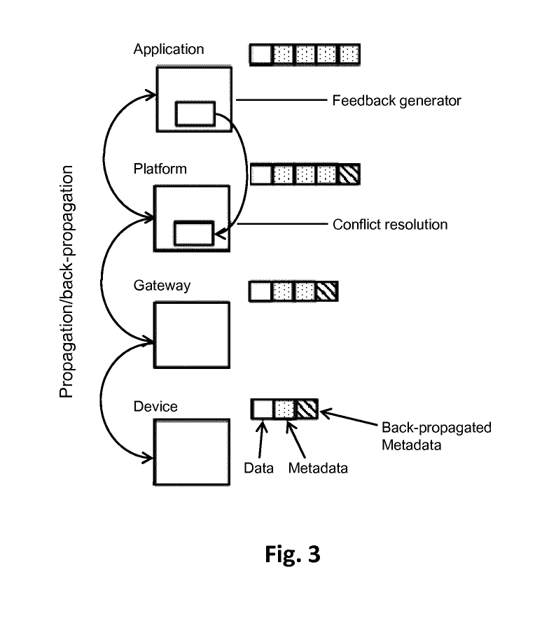

FIG. 3 is a schematic view illustrating a hierarchical level architecture for an embodiment of a method or a system according to the present invention with vertical data/metadata propagation and back-propagation, and

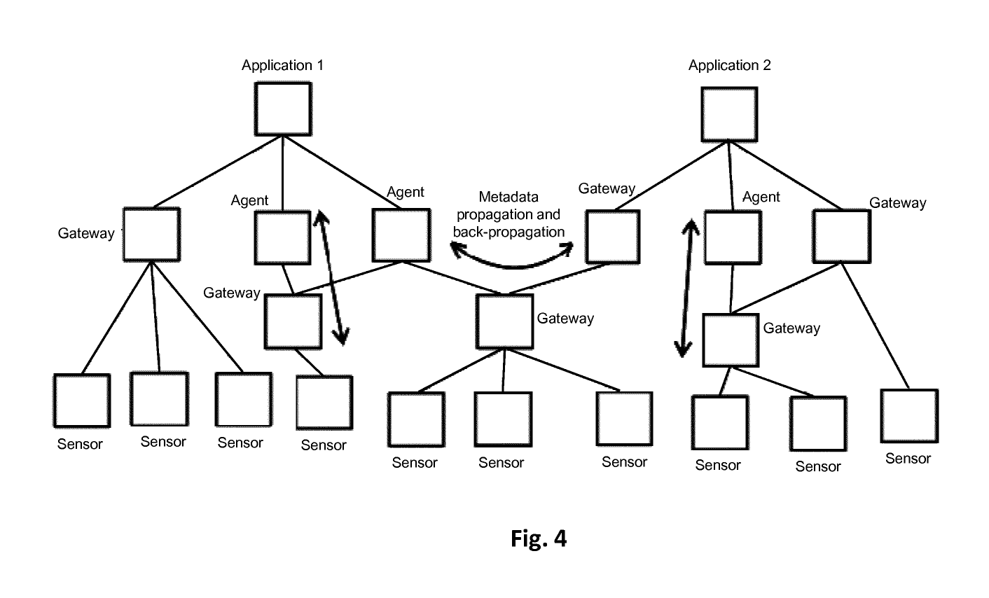

FIG. 4 is a schematic view illustrating a system wide data/metadata propagation and back-propagation introduced by an embodiment of a method or a system according to the present invention.

FIG. 1 shows a schematic view illustrating an example of an application scenario of a method or a system according to the present invention. Specifically, FIG. 1 shows the hierarchy of the architecture with several levels. At the bottom level sensors generates data in the form of an entity which is propagated within the hierarchical architecture via gateways and/or agents and via a cloud platform for machine-to-machine systems up to an application of the application level. The embodiment of a method or a system according to the present invention illustrated in FIG. 1 combines in a sophisticated way mechanisms of metadata augmentation, maintenance, and valuation/accounting in order to provide:
Automated data augmentation with additional metadata to increase the utility of the data for owner and the third party users
   Metadata engine at the gateway/agent
   Metadata shared and back-propagated by applications
Accounting mechanism for the metadata utility along with a metadata marketplace providing an accounting function
Feedback mechanism evaluating Quality of Information (QoI) of used metadata

The embodiment described in FIG. 1 offers a method and a system for automated metadata generation, aggregation, and maintenance. The gateways and/or agents being placed higher in the architecture hierarchy can easily aggregate data/metadata, i.e. entities, originating from the lower level of the hierarchy and then propagate it further within the hierarchical architecture in order to allow further aggregation. The rule that is used for generating/aggregating the metadata may depend on the gateway/agent metadata which specifies it inherent properties, and the set of possible metadata transformations of the gateway and/or agent.

The embodiment of FIG. 1 may be used for an application scenario in the context of body temperature measurements and Personal Area Networks (PANs). For example, each child is carrying a set of devices/sensors that belong to a Personal Area Network (PAN). To the measurements taken from the temperature sensor belonging to the PAN may be assigned the location of the child. Moreover, when the child comes to school, its body temperature can be further aggregated and/or processed by the school system. Thus, each child ultimately can receive metadata describing its health state, derived from average child temperature.

Applications working on data sets produce processed output data. This output data has a high value due to the cost involved in creating it, namely the cost of the input data and processing cost. According to the concept of back-propagation, these processed data can be valuable as metadata for the existing data, e.g. a temperature value can advantageously have attached as metadata its trend based on the computed weather forecast.

According to the embodiment of FIG. 1, an incentive for the applications owners to share the results produced by their applications is provided. Situations without such an incentive may lead to often processing the same or similar set of data by different applications for the same purpose. Specifically, the way to incentivize data/metadata sharing in the cloud and M2M systems—according to the embodiment of FIG. 1—is implemented by the establishment of the data/metadata marketplace which provides an accounting function for valuing the data/metadata.

The accounting function of the marketplace can assign the credit cost as well as the QoI describing the data/metadata. The applications may be rewarded with a credit for providing the data/metadata to the marketplace, and/or may receive credit directly from users of the metadata. The accumulated credit can be used by applications for accessing more valuable data/metadata with higher QoI in order to be able to produce more accurate results, or shorten the processing, what translates in shorter response times.

In case of an application scenario with temperature measurement and weather prediction, a first application would receive credit for providing the calculated weather trend, the value of the credit may depend on the size of dataset used for calculation. To this extent, a larger dataset may render higher confidence. The weather trend metadata assigned to the temperature data can also be tagged with credit price and additionally QoI in this case describing the freshness of the prediction and size of data set used for calculation. A second application is able to decide to use the raw data at no cost or to use its credit to acquire additional weather trend metadata in order to increase reliability of its processing.

Furthermore, in order to maintain valid QoI of the data/metadata, the application using the data/metadata should have possibility to provide the feedback regarding QoI. The feedback may result in change to the value of the data and/or stripping some of its metadata rated invalid. The act of providing feedback should also be encouraged by assigning the credit.

The second application after using the additional metadata can provide feedback regarding the metadata QoI. The second application could evaluate the QoI feedback, for example, by comparing the correctness of results achieved using the metadata and without it.

The accounting function of the marketplace in the cloud providing the data/metadata can also back-propagate the QoI downwards in the architecture hierarchy. Thus, the sensors and gateways may also be rated in regards of their performance and importance.

FIG. 2 is a schematic view illustrating an example of an information model according to an embodiment of the present invention. According to FIG. 2 each data is modeled as an entity. In doing so each entity is described by metadata (key, value pairs), wherein this metadata may describe static properties of the entity. For example, the entity is a temperature sensor and a static property of the temperature sensor may be the available measuring scale of the sensor.

Additionally, according to the information model of FIG. 2, the entity comprises one or more context attributes. Each context attribute comprises a value defined by the data type and is additionally described by metadata which describes variable properties of the entity. For example, the context attribute may represent the measured value of the sensor and the metadata of the context attribute indicates the location or time of the performed measurement.

FIG. 3 is a schematic view illustrating a hierarchical level architecture of an embodiment of a method or a system according to the present invention with vertical data/metadata propagation and back-propagation.

The embodiment—described in FIG. 3—of a method or a system according to the present invention has the capability of back-propagating created or derived information, e.g. from aggregating entities, to the lower level of the architecture hierarchy to provide the metadata/entities that could not be locally concluded. The back-propagation can take place from any higher level in the hierarchical architecture to lower level. An especial important example of this back-propagation is the case of an application that decides to publish its processed information data in the form of feedback information back to the lower levels of the architecture.

This feedback information may be:
Entity: e.g. completely new information data
Metadata: e.g. new information that is valid only in relation to an existing entity that the metadata describes
Quality of Information (QoI): valuation of usefulness and correctness of an existing entity and/or metadata.

As depicted in FIG. 3, the QoI provided as feedback information may require further evaluation for conflict resolution as it may happen that the entity/metadata stored at a lower level may receive contradicting feedback information from the upper level. Technically the QoI can be stored as well defined metadata.

FIG. 4 is a schematic view illustrating a system wide data/metadata propagation and back-propagation introduced by an embodiment of a method or a system according to the present invention.

The concept of entity—i.e. data and/or metadata—propagation and back-propagation that is illustrated in FIG. 4 is described in consideration of an application scenario providing temperature data collection and weather prediction.

FIG. 4 depicts a hierarchical level architecture, wherein the sensors at the bottom of the hierarchical architecture take periodic temperature measurements. Those measurements are sent upward within the architecture hierarchy, going through gateways and agents and a cloud platform—not depicted in FIG. 4—up to the application level. On each level there is possible aggregation, e.g. the mean temperature value is calculated but the entity can also be forwarded in its raw form, i.e. without additional metadata. The difference between the calculated mean value and the measured value can be added as metadata describing the temperature deviation on each level of the hierarchical architecture, where each higher level encompasses a larger set of measurements. Ultimately, entities representing sensor-originated data together with included/added metadata reach the application level, namely Application 1. Application 1 provides weather prediction processing. Depending on requirements, e.g. a time deadline, Application 1 may operate on the complete set of raw data or try to speed-up the processing, while scarifying the accuracy, by using the mean values and average deviation provided as metadata, included in the propagated entities. The results from the Application 1 processing, e.g. the temperature trend, can be back-propagated to the lower levels in the hierarchical architecture.

In the considered case, each temperature data represented by an entity can be additionally augmented by the application with the expected temperature trend. This back-propagated metadata, while reaching lower levels of the architecture, will start once again to be propagated, e.g. by agents and/or gateways. Thus, it is enabled that the metadata will also be propagated horizontally within the platform, so also other applications, e.g. Application 2, not directly belonging to the data flow tree will be able to access the metadata. The horizontal propagation of the data and metadata can also take place in the cloud platform, where the complete collection of the data and/or metadata, i.e. the entities, can be stored.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for supporting automated metadata augmentation in a hierarchical level architecture for machine-to-machine (M2M) cloud computing,
wherein metadata is employed to provide descriptive information about entities,
wherein said entities are generated at a lower level of said architecture, in particular at the bottom level of said architecture,
wherein said entities are propagated from said lower level, in particular via one or more levels, upwards to an upper level of said architecture, in particular to the application level of said architecture, and
wherein metadata is added to said entities on one or more of the levels of said architecture,
charactarized in that feedback information based on one or more of said entities is generated at said upper level of said architecture, and
wherein said feedback information is propagated downwards in said architecture.

2. Method according to claim 1, wherein said entities include device-generated information, in particular sensor-generated information comprising a value that is measured by a sensor located at the bottom level of said architecture.

3. Method according to claim 1, wherein said entities are propagated via one or more gateways of one or more levels of said architecture and/or via a cloud platform to an application of the application level of said architecture.

4. Method according to claim 3, wherein said gateways comprise a metadata engine for adding metadata to said entities, wherein said metadata is based on aggregated information obtained by one or more entities originated from a lower level of said architecture, and wherein said entities with the added metadata are further propagated upwards within the architecture.

5. Method according to claim 1, wherein said feedback information is created and/or derived on the basis of aggregated information obtained by one or more entities originated from a lower level of said architecture.

6. Method according to claim 1, wherein said feedback information is created and/or derived on the basis of results from application processing at the application level of said architecture.

7. Method according to claim 1, wherein said feedback information includes a new entity with new information data.

8. Method according to claim 1, wherein said feedback information includes information data related to an entity, wherein said feedback information is added to the entity as additional metadata.

9. Method according to claim 1, wherein said feedback information includes a calculated mean value, a deviation value, an average deviation value and/or a trend value, etc. as information data.

10. Method according to claim 1, wherein said feedback information includes a rating regarding the Quality of Information (QoI) of an entity as information data, wherein said rating relates to the fitness of said entity and/or the metadata of said entity.

11. Method according to claim 1, wherein a conflict resolution is performed in case of contradicting feedback information is received from different creators, in particular applications, generating feedback information.

12. Method according to claim 1, wherein said feedback information is employed for augmenting, updating and/or maintaining entities at one or more of the lower levels of said architecture, wherein said entities are further propagated within said architecture.

13. Method according to claim 1, wherein entities are shared by applications of the application level via a cloud platform.

14. Method according to claim 1, wherein the sharing of said entities is implemented by establishing an accounting function for valuing said entities and/or the metadata of said entities at the level of the cloud platform, and wherein said accounting function provides said entities and/or the metadata of said entities to applications of the application level.

15. Method according to claim 14, wherein an application that provides feedback information to said accounting function is rewarded with a credit, wherein said credit is employed to access other entities being provided by said accounting function.

16. Method according to claim 1, wherein said entities include metadata describing static properties of said entities, wherein said entities further include one or more context attributes describing variable properties of said entities, and wherein said context attributes include descriptive metadata and a value.

17. System for supporting automated metadata augmentation, in particular for executing a method according to claim 1, wherein said system comprises a hierarchical level architecture for machine-to-machine (M2M) cloud computing, wherein said system is configured
to employ metadata for providing descriptive information about entities,
to generate entities at a lower level of said architecture, in particular at the bottom level of said architecture,
to propagate said entities from said lower level, in particular via one or more levels, upwards to an upper level of said architecture, in particular to the application level of said architecture, and
to add metadata to said entities on one or more of the levels of said architecture,
charactarized in that said system is further configured
to generate feedback information based on one or more of said entities at said upper level of said architecture and
to propagate said feedback information downwards in said architecture.
